(19) United States
(12) Patent Application Publication
(10) Pub. No.: US 2013/0345034 A1
(43) Pub. Date: Dec. 26, 2013

(54) Fast Tool Changing System by Means of Synchronizing Displacement and Linkage of Main Spindle and Tool Magazine

(71) Applicant: Yi-Jun Liu, Taichung City (TW)

(72) Inventor: Yi-Jun Liu, Taichung City (TW)

(21) Appl. No.: 13/532,709

(22) Filed: Jun. 25, 2012

(51) Int. Cl. B23Q 3/157

(52) U.S. Cl. 483/38

(57) ABSTRACT

A fast tool changing system by means of synchronizing displacement and linkage of a main spindle is provided, wherein when a servo-motor drives the main spindle to raise or drop, two linkage panes, which are provided at two lateral sides of the main spindle respectively and each of which comprises a flat portion and a concave portion defining a height difference, can synchronizing move. The roller wheel, which is provided on a roller wheel adjusting base at a lateral side of the cool magazine, slides on the linkage panel. Because of the heath difference, the swing arm is driven to swing, so that action of fast tool changing by means of synchronizing displacement and linkage of the main spindle can be achieved.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a fast tool changing system via synchronizing linkage of a tool magazine, wherein a roller wheel, which is provided on a roller wheel adjusting base at a lateral side of the tool magazine, slides between a flat portion and a concave portion of a linkage panel, so as to achieve the fast tool changing performance via synchronizing linkage of the tool magazine. A swing arm, which is pivotally connected to the tool magazine frame, has a groove provided in a front end portion thereof for receiving an enhanced pre-pressed torsional spring. A penetrating mandrel and a screw are used to fix the enhanced pre-pressed torsional spring, so that the upper tool tray of the tool magazine casing body coupled with the swing arm, the roller wheel adjusting base, and the roller wheel are retained in position by the enhanced pre-pressed torsional spring and do not vibrate. The roller wheel slides smoothly on the flat portion and the concave portion of the linkage panel. In addition, cutting tools are prevented from being dropped down or fly away is obtained by the interaction between the tool tray interval retracting system and the tool clamping base, so that the fast tool changing performance via synchronizing linkage of the tool magazine is achieved.

2. Description of Related Arts

A conventional tool changing system of a machining center such as, a carousel tool bank, uses a cylinder to push the tool tray to the center of a main spindle for slotting the cutting tool, and then after the main spindle releases the cutting tool so as to ensure the system is in a tool changing position, a tool tray motor drives to retain the cutting tool in a releasing position. A tool handle of the main spindle is dropped down and a tool clamping cylinder is moved to a right position, the cylinder of the tool magazine at the tool tray is returned to the original position of the tool magazine, and the main spindle begins to work. The time for the whole tool magazine to accomplish this action and the main spindle to change tools is about nine seconds. The costs are low but, the tool changing speed is not competitive and the economical efficiency is relatively low. The tool tray does not have a locking device for clamping the cutting tool in position, so that the tools may drop down. In addition, a mechanical hand tool changing tool magazine using the main spindle to change tool requires, zero correction and ensuring the tool retaining angle and location of the tool. The mechanical hand tool magazine uses a tool holder cylinder to upset the cutting tool, and then, the tool retaining angle of tool arm, the position of the handle of the main spindle, and the releasing of the cutting tool by the main spindle are ensured. The tool arm of the mechanical hand pulls downward the cutting tool, so that the cutting tool detaches from the tool handle of the main spindle and rotates 180° and thus the action of tool changing is achieved. And then, after the mechanical hand is elevated to a position corresponding to the main spindle and tool holder. The grasping handle of the main spindle and the tool arm of the mechanical hand are returned to their original position. The operation processing can then be restarted. The components of such a system are too many, and the structure is relatively complicated so that when the main spindle-tool magazine system and the mechanical hand are changing the tools, dropping down and/or flying away of the tools may take place. While this is not safe, the after-service and maintenance is inconvenient, and the costs are relatively high.

The inventor herein has been manufacturing a tool changing system for the machining center and related products for many years and is full educated about the disadvantages. Thus, the inventor is devoted in overcoming the disadvantages of the prior art and in developing a fast tool changing system that is more practical and meets the requirements of the users. Finally, after many years' of effort in experimenting and development, the present invention is described in the following disclosure.

### SUMMARY OF THE PRESENT INVENTION

The invention is advantageous in that, it provides a fast tool changing system by means of synchronizing displacement and linkage of a main spindle and a tool magazine, wherein, the system comprises: a machine body, a servo-motor provided thereon for driving the main spindle to raise or drop, two linkage panels provided at two lateral sides of the man spindle respectively, which can simultaneously move with the main spindle wherein, each of the linkage panel comprises a flat portion and a concave portion which has a height difference, and a roller wheel sliding on the linkage panel in such a manner that the height difference press down a swing arm because of rotation of an enhanced pre-pressed torsional spring, so that the action of synchronizing displacement and linkage of the tool magazine is achieved. Two single rod bearings are provided at two lateral sides of the swing arm for keeping the swing arm from vibrating and the swing arm can move smoothly when rotating.

A tool magazine frame, which is provided at a front side of the machine body, comprises a fixing base provided therein. The swing arm can be pivotally connected to the fixing base. The swing arm has a groove provided at a front side thereof for receiving an enhanced pre-pressed torsional spring. A penetrating mandrel and a fixing screw are used to fix the enhanced pre-pressed torsional spring. Because of the enhanced pre-pressed torsional spring, the tool magazine casing body which is coupled with the swing arm, the roller wheel pivotally connected to the lateral roller wheel adjusting base, and the tool tray coupled with the tool magazine casing body does vibrate when the roller wheel slide smoothly on the flat portion and the concave portion of the linkage panel. A distal end of the swing arm is connected to the tool magazine which comprises the tool magazine casing body therein. The tool magazine casing body comprises a tool tray interval retracting system for driving a motor which is coupled with a transmission wheel for activating a tool magazine projecting wheel, a projecting wheel gear, and a projecting wheel mandrel. A positioning signal block is provided on the projecting wheel mandrel for cooperating with a stage switch. The tool magazine projecting wheel activates an index single rod bearing, so that the tool tray can rotate to select a cutting tool, and after the tool tray selects the cutting tool, the main spindle moves downward to clamp the cutting tool, a releasing pushing block pushes against a tool locking arm on a tool clamping base, so that the action of tool changing can be achieved. The roller wheel adjusting base, which is pivotally connected to the roller wheel, is provided at a lateral side of the tool magazine casing body. The front side of the tool magazine casing body is coupled with the tool tray. A driving motor is provided at a lateral side of the tool magazine casing body for driving the tool magazine projecting wheel and the tool tray. When the servo motor drives the tool magazine projecting wheel to raise, the linkage panel synchronizing moves, the roller wheel which is provided on the roller wheel adjusting base at the lateral side of the tool magazine casing body slides on the linkage panel, so that the action of tool changing by means of synchronizing displacement and linkage of the tool magazine is achieved. Each of the cutting tools along the outer circumference of the tool tray is provided with a tool clamping base, wherein the tool clamping base is provided with the tool locking arm and the releasing spring 18 thereon. The tool locking arm and the releasing spring are coupled with the releasing pushing block to accomplish the action of locking or releasing of the cutting tools. Dropping down and flying away of the cutting tools are also prevented during the tool changing operation.

When the main spindle is in operation changing a cutting tool, the tool clamping base on the tool tray is in a state waiting for clamping a cutting tool, the servo-motor drives the main spindle and the linkage panel to move upward, the roller wheel slides from the flat portion to the concave portion of the linkage panel, the height difference between the flat portion and the concave portion makes the enhanced pre-pressed torsional spring to guide the swing arm to rotate downward, wherein, the tool clamping base on the tool tray which is waiting for clamping a cutting tool, retains the cutting tool which is going to be substituted in position. After the tool clamping base locks the cutting tool in position, the servo-motor drives the main spindle to move upward in order to withdraw the cutting tool. The tool tray interval retracting system can be used to control the selection of the cutting tools. After the cutting tool is selected, the servo-motor drives the main spindle to move downward to clamp the cutting tool. When the main spindle has been holding the cutting tool in position, the tool locking arm on the tool clamping base is pushed against by the releasing pushing block so that the cutting tool is released. And then the servo-motor continues to drives the main spindle to move downward to be at a working position. The roller wheel slides from the concave portion to the flat portion of the linkage panel and is then retained in position, the tool clamping base on the tool tray is in a state waiting for tool changing. Accordingly, when the main spindle is in operation and changing a cutting tool, the enhanced pre-pressed torsional spring can rotate and bias against the swing arm, so that the tool magazine coupled with the swing arm will not shake.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a plane schematic view of a conventional carousel tool bank.

FIG. 2 is a plane schematic view of a mechanical hand tool changing tool magazine.

FIG. 3 is a perspective view of a tool changing system according to a preferred embodiment of the present invention.

FIG. 4 is a schematic view of the tool tray interval retracting system according to the above preferred embodiment of the present invention.

FIG. 5 is a schematic view of the enhanced pre-pressed torsional spring according to the above preferred embodiment of the present invention.

FIG. 6 is a sectional view of the tool changing system according to the above preferred embodiment of the present invention.

FIG. 7 is a schematic view illustrating the tool clamp being in a state not clamping a cutting tool and being waiting for tool changing according to the above preferred embodiment of the present invention.

FIG. 8 is a schematic view illustrating the tool clamp clamping the cutting tool according to the above preferred embodiment of the present invention.

FIG. 9 is a schematic view illustrating the main spindle withdrawing the cutting tool and the tool magazine selecting the cutting tool according to the above preferred embodiment of the present invention.

FIG. 10 is a schematic view illustrating the main spindle clamping the cutting tool according to the above preferred embodiment of the present invention.

FIG. 11 is a plane schematic view of the tool clamp according to the above preferred embodiment of the present invention.

### DETAILED DESCRIPTION OF THE PREFERRED EMBODIMENT

The following description is disclosed to enable any person skilled in the art to make and use the present invention. Preferable embodiments are provided in the following description only as examples and modifications will be apparent to those skilled in the art. The general principles defined in the following description would be applied to other embodiments, alternatives, modifications, equivalents, and applications without departing from the spirit and scope of the present invention.

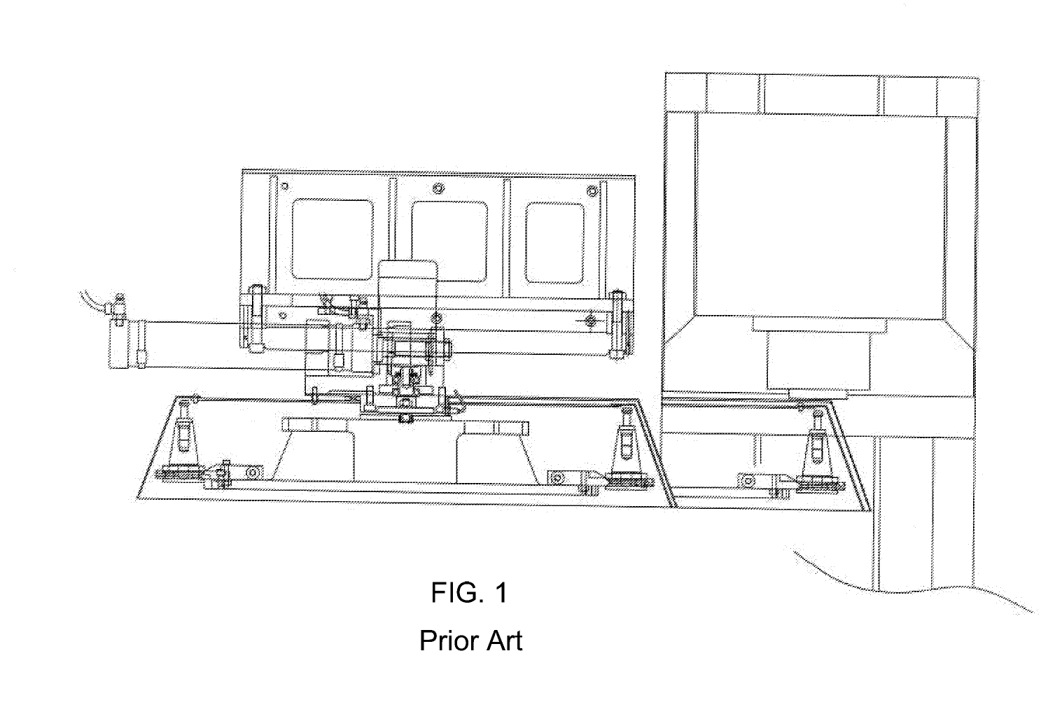

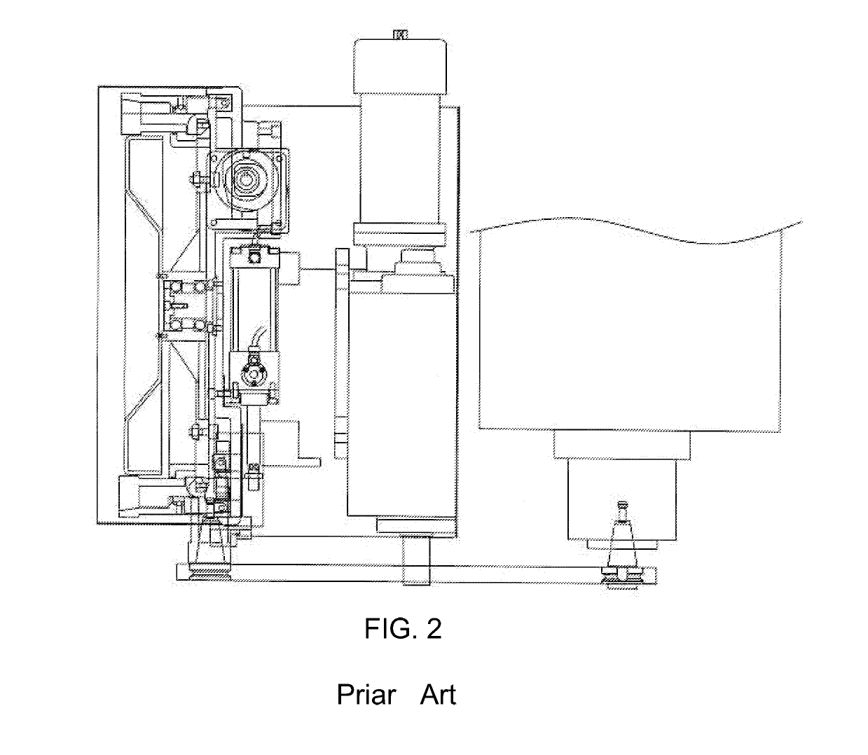

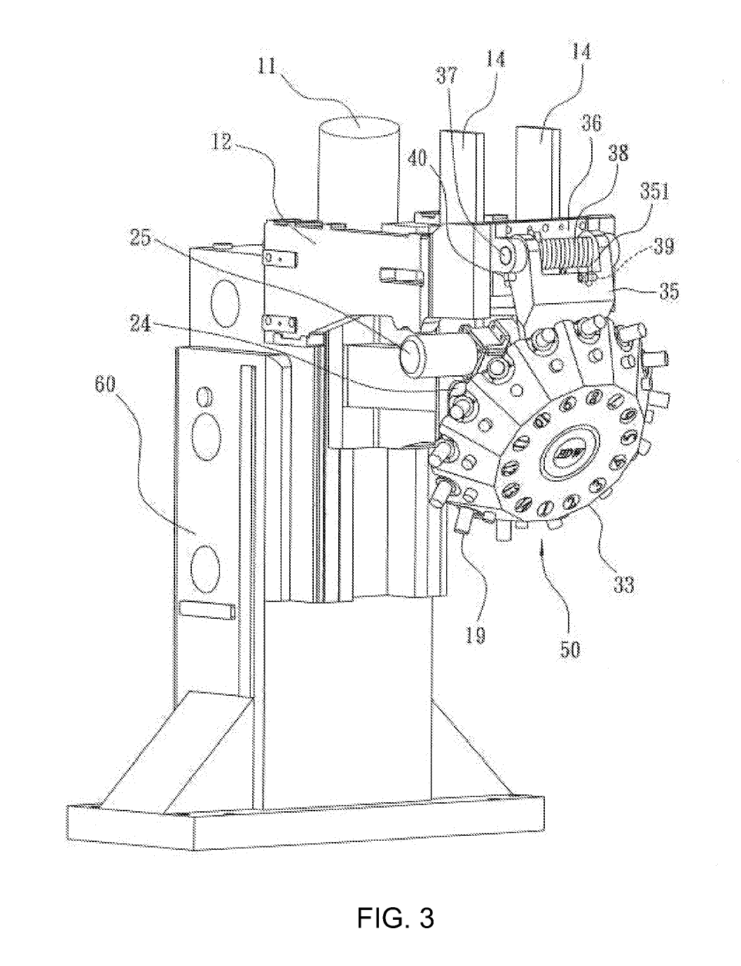

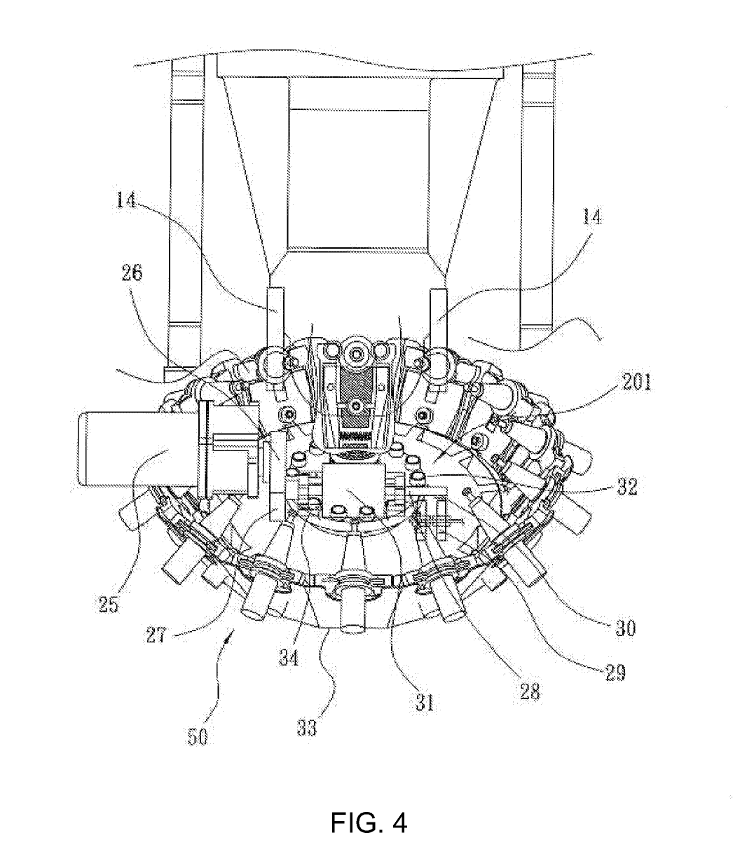

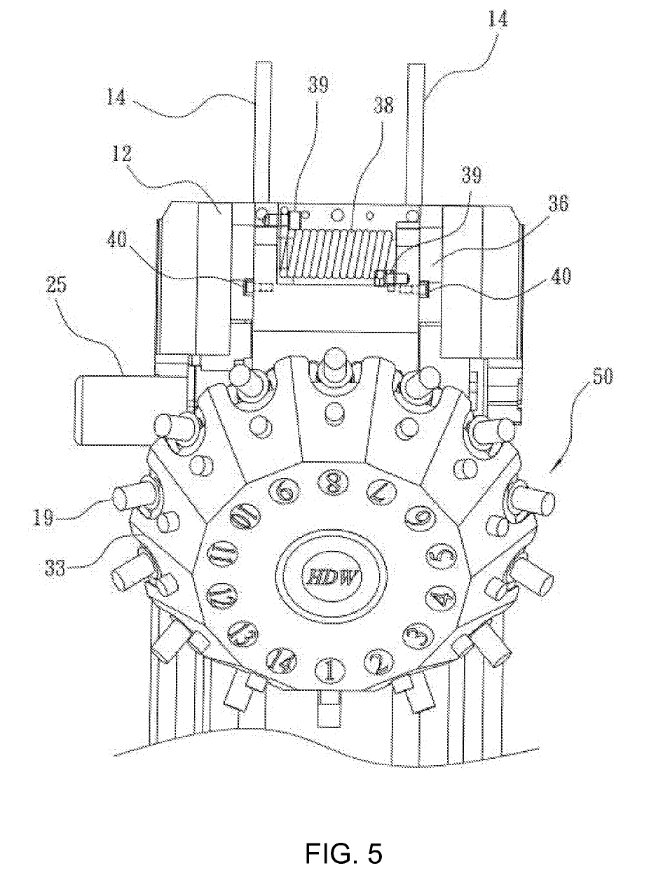

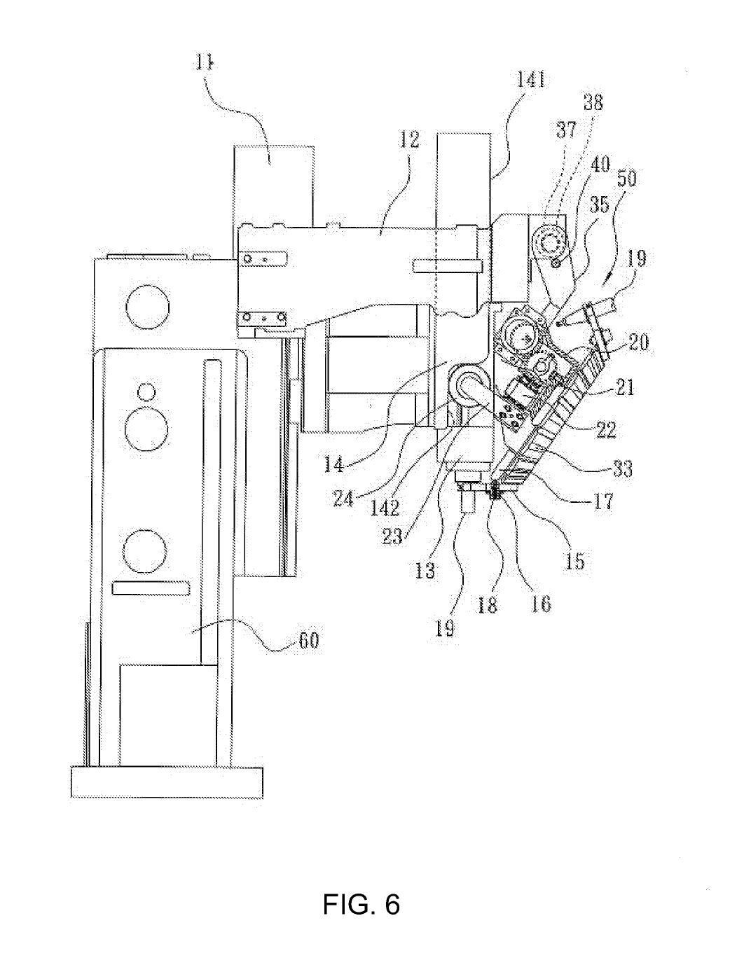

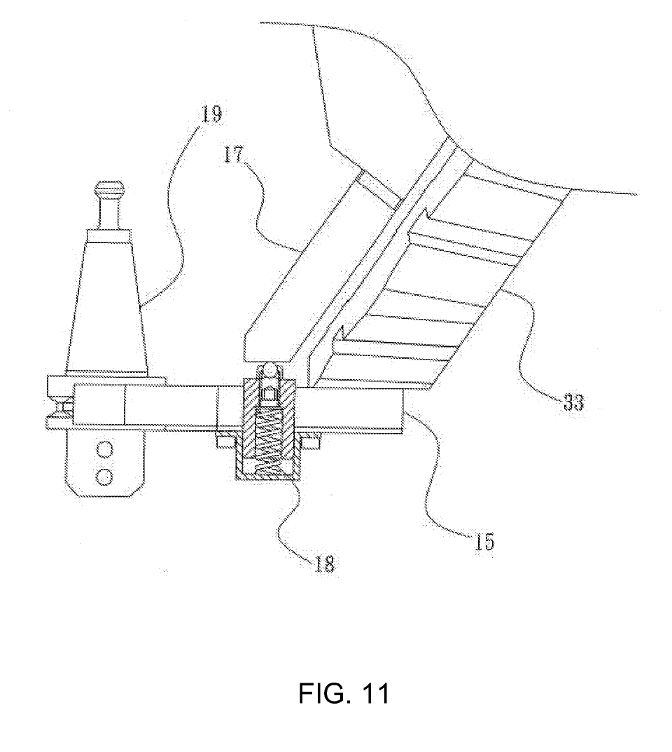

Referring to FIG. 1 to FIG. 11 of the drawings, a fast tool changing system by means of synchronizing displacement and linkage of a main spindle and a tool magazine, wherein the system comprises a machine body 60, a servo-motor 11 provided thereon for driving the main spindle 13 to raise or drop, two linkage panels 14 provided at two lateral sides of the man spindle 13 respectively which can simultaneously move with the main spindle 13 wherein each of the linkage panels 14 comprises a flat portion 141 and a concave portion 142 having a height difference, and a roller wheel 24 sliding on the linkage panel 14 in such a manner that the height difference makes a swing arm 35 pressing down because of rotation of an enhanced pre-pressed torsional spring 38, so that the action of synchronizing displacement and linkage of the tool magazine 50 is achieved. Two single rod bearings 40 are provided at two lateral sides of the swing arm 35 for keeping the swing arm 35 from shaking and the swing arm 35 can move smoothly during rotation.

A tool magazine frame 12, which is provided at a front side of the machine body 60, comprises a fixing base 36 provided therein. The swing arm 35 can be pivotally connected to the fixing base 36. The swing arm 35 has a groove 351 provided at a front side thereof for receiving an enhanced pre-pressed torsional spring 38. A penetrating mandrel 37 and a fixing screw 39 are used to fix the enhanced pre-pressed torsional spring 38. Because of the enhanced pre-pressed torsional spring 38, the tool magazine casing body 20 which is coupled with the swing arm 35, the roller wheel 24 pivotally connected to the lateral roller wheel adjusting base 23, and the tool tray 33 coupled with the tool magazine casing body 20 do not vibrate when the roller wheel 24 slides smoothly on the flat portion 141 and the concave portion 142 of the linkage panel 14. A distal end of the swing arm 35 is connected to the tool magazine 50 which comprises the tool magazine casing body 20 therein. The tool magazine casing body 20 comprises a tool tray interval retracting system 201 for driving a motor 25 which is coupled with a transmission wheel 26 for activating a tool magazine projecting wheel 31, a projecting wheel gear 27, and a projecting wheel mandrel 28. A positioning signal block 30 is provided on the projecting wheel mandrel 28 for cooperating with a stage switch 29. The tool magazine projecting wheel 31 activates an index single rod bearing 32, so that the tool tray 33 can rotate to select a cutting tool and, after the tool tray 33 selects the cutting tool, the main spindle 13 moves downwards to clamp the cutting tool and a releasing pushing block 17 pushes against a tool locking arm 16 on a tool clamping base 15, so that the action of tool changing can be achieved. The roller wheel adjusting base 23, which is pivotally connected to the roller wheel 24, is provided at a lateral side of the tool magazine casing body 20. The front side of the tool magazine casing body 20 is coupled with the tool tray 33. A driving motor 25 is provided at a lateral side of the tool magazine casing body 20 for driving the tool magazine projecting wheel 31 and the tool tray 33. When the servo motor 11 drives the tool magazine projecting wheel 31 to raise, the linkage panel 14 moves simultaneously and the roller wheel 24 which is provided on the roller wheel adjusting base 23 at the lateral side of the tool magazine casing body 20 slides on the linkage panel 14, so that the action of tool changing by means of synchronizing displacement and linkage of the tool magazine 50 is achieved. Each of the cutting tools 19 along the outer circumference of the tool tray 33 is provided with a tool clamping base 15, wherein the tool clamping base 15 is provided with the tool locking arm 16 and the releasing spring 18 thereon. The tool locking arm 16 and the releasing spring 18 are coupled with the releasing pushing block 17 to accomplish the action of locking or releasing of the cutting tools 19. Dropping down and flying away of the cutting tools are also prevented during the tool changing operation.

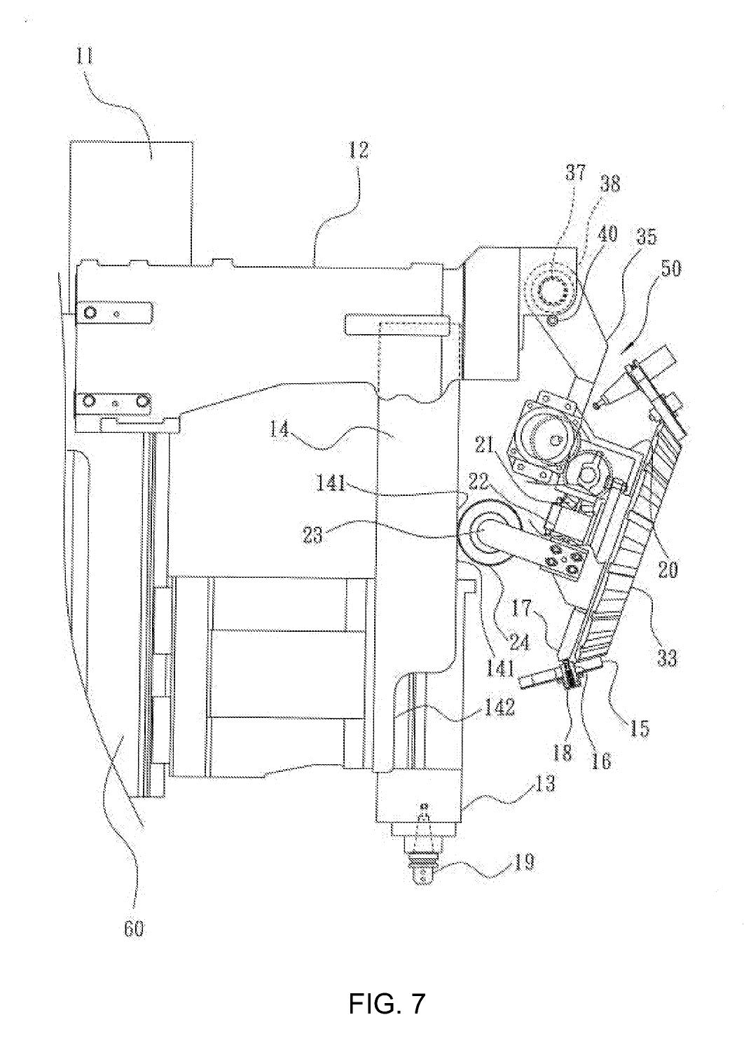

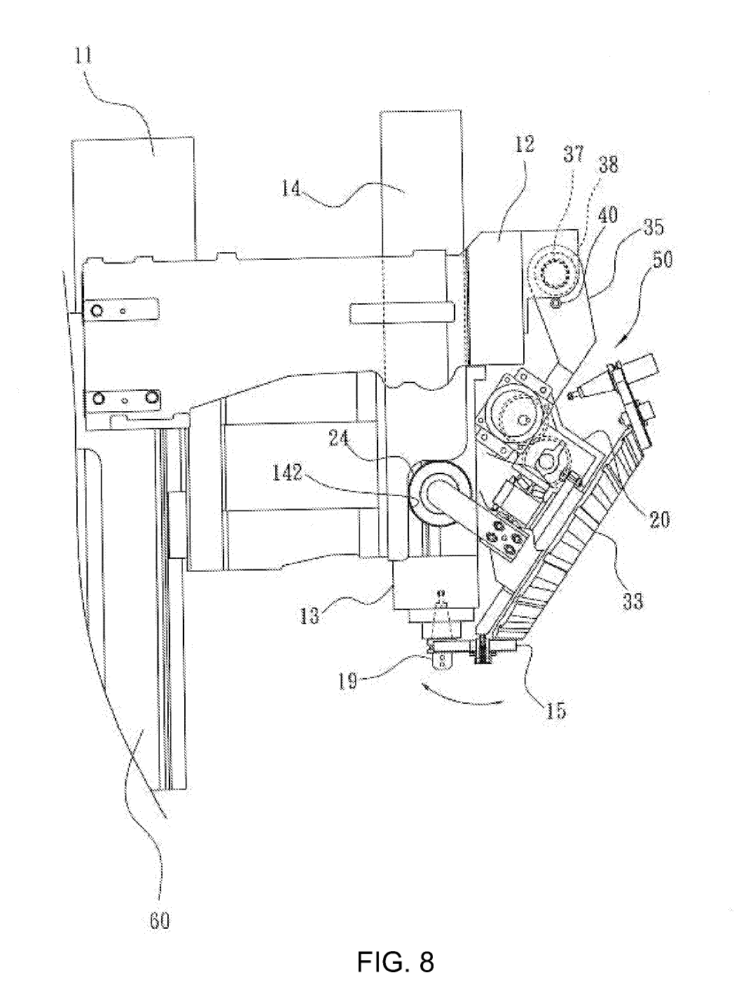

When the main spindle 13 is in operation to change a cutting tool, referring to FIG. 7 of the drawings, the tool clamping base 15 on the tool tray 33 is in a state waiting for clamping a cutting tool. The servo-motor 11 drives the main spindle 13 and the linkage panel 14 to move upwards. And, the roller wheel 23 slides from the flat portion 141 to the concave portion 142 of the linkage panel 14. Referring to FIG. 8 of the drawings, the height difference between the flat portion 141 and the concave portion 142 makes the enhanced pre-pressed torsional spring to guide the swing arm 35 to rotate downwardly, wherein the tool clamping base 15 on the tool tray 33, which is waiting for clamping a cutting tool, retains the cutting tool 19 in position which is going to be substituted. This step is defined as the tool locking action of the tool clamping base 15.

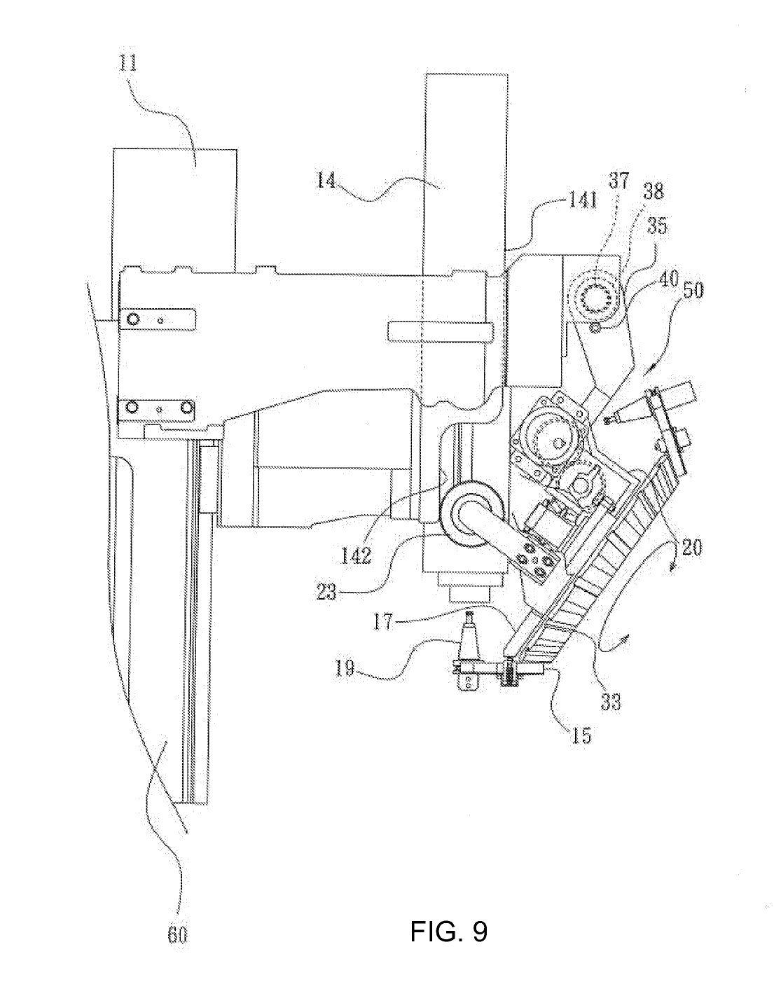

After the tool clamping base 15 locks the cutting tool 19 in position, the servo motor 11 drives the main spindle 13 to move upwards to withdraw the cutting tool. As shown in FIG. 9 of the drawings, the tool tray interval retracting system 201 can be used to control the selection of the cutting tools. This step is defined as the action of withdrawing tools of the main spindle 13 and selecting tools of the tool magazine 50.

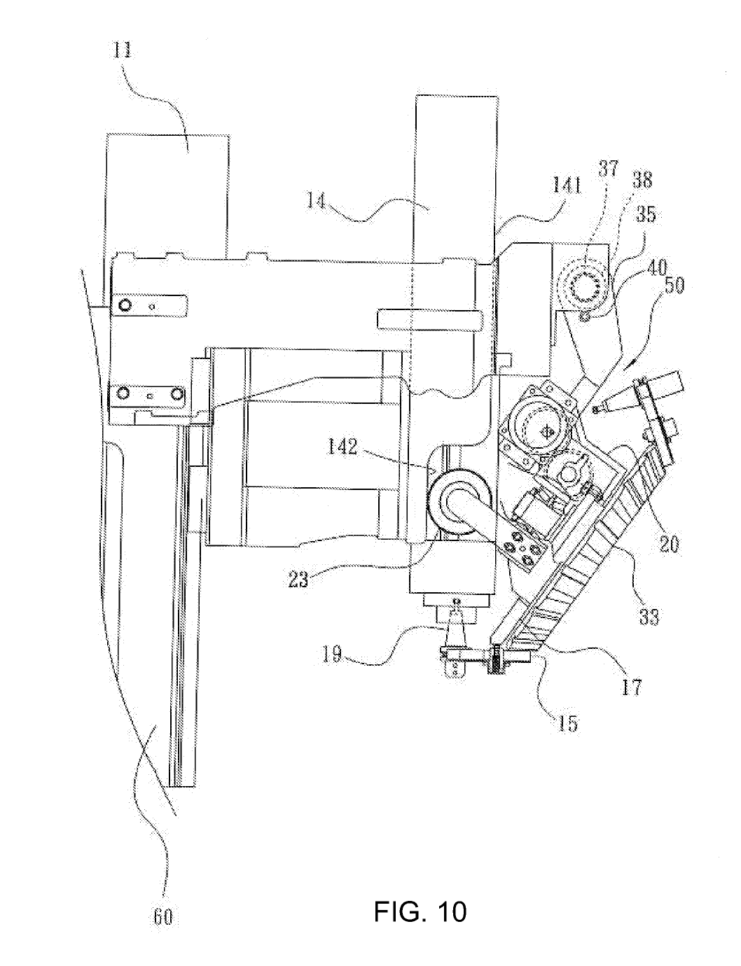

After the cutting tool is selected, the servo motor 11 drives the main spindle 13 to move downwards to clamp the cutting tool, as shown in FIG. 10 of the drawings. This step is defined as the tool clamping action of the main spindle 13.

When the main spindle has been holding the cutting tool in position, the tool locking arm 16 on the tool clamping base 15 is pushed against by the releasing pushing block 17 so that the cutting tool is released. And then, the servo motor 11 continues to drives the main spindle 13 to move downwards to be at a working position. The roller wheel 24 slides from the concave portion 142 to the flat portion 141 of the linkage panel 14 and is then retained in position. The tool clamping base 15 on the tool tray 13 is in a state waiting for tool changing. Accordingly, when the main spindle 13 is in operation and changing a cutting tool, the enhanced pre-pressed torsional spring can rotate and bias against the swing arm 35, so that the tool magazine 50 coupled with the swing arm 35 will not vibrate.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention, and is subject to change without departure from such principles. Therefore, this invention includes all modifications encompassed within the spirit and scope of the following claims.

What is claimed is:

1. A fast tool changing system by means of synchronizing displacement and linkage of a main spindle and a cool magazine, comprising:
a machine body;
a servo motor provided thereon for driving said main spindle to raise or drop;
two linkage panels, which are provided at two lateral sides of said man spindle respectively, simultaneously moving with said main spindle, wherein each of said linkage panels has a flat portion and a concave portion defining a height difference therebetween;
a tool magazine frame provided at a front side of said machine body;
a swing arm pivotally connected to said tool magazine frame, wherein a groove is provided in a front portion of said swing arm;
an enhanced pre-pressed torsional spring received in said groove, wherein said tool magazine is coupled with a distal end of said swing arm;
a tool magazine casing body provided in said tool magazine;
a tool tray interval retracting system provided in said tool magazine casing body;
a motor;
a transmission wheel;
a tool magazine projecting wheel;
a projecting wheel gear;
a projecting wheel mandrel;
a positioning signal block provided on said projecting wheel mandrel;
a stage switch coupled with said positioning signal block, wherein said tool magazine interval retracting system drives motor to engage with said transmission wheel to guide said tool magazine projecting wheel, said projecting wheel gear, and said projecting wheel mandrel to move;
a roller wheel adjusting base provided at a lateral side of said tool magazine casing body;
a roller wheel pivotally connected to said roller wheel adjusting base;
a tool tray coupled with a front side of said tool magazine casing body, wherein said motor is provided at said lateral side of said tool magazine casing body for driving said tool magazine projecting wheel and said tool tray; and
a servo-motor, wherein when said servo motor drives said main spindle to raise or drop, said linkage panel is moving simultaneously and correspondingly, wherein said roller wheel, which is provided on said roller wheel adjusting base at said lateral side of said tool magazine, slides on said linkage panel, so that action of fast tool changing by means of synchronizing displacement of said tool magazine is achieved, wherein a plurality of cutting tools are provided along an outer circumference of said tool tray, wherein each of said cutting tools is provided with a tool clamping base for retaining said cutting tool in position.

2. The fast tool changing system, as recited in claim 1, further comprising an index single rod bearing, a releasing pushing block, and a tool locking arm provided on said tool clamping base, wherein through interaction of said stage switch on said projecting wheel mandrel and said positioning signal block, said tool magazine interval retracing system guides said tool magazine projecting wheel to drive said index single rod bearing for said tool tray to select one of said cutting tools, wherein after said main spindle moves downwards to clamp one of said cutting tools, said releasing pushing block pushes against said tool locking arm on said tool clamping base, so that action of tool changing is achieved.

3. The fast tool changing system, as recited in claim 1, wherein said tool clamping base comprises a tool locking arm and a releasing spring, wherein said fast tool changing system further comprises a releasing pushing block coupled with said tool locking arm and said releasing spring to accomplish actions of tool locking and tool releasing, so as to prevent dropping down and flying away of the cutting tools.

4. The fast tool changing system, as recited in claim 1, wherein said enhanced pre-pressed torsional spring is received in said groove which is at said front side of said swing arm, wherein a penetrating mandrel and a fixing screw are used to retain said enhanced pre-pressed torsional spring in position.

5. The fast tool changing system, as recited in claim 1, wherein said enhanced pre-pressed torsional spring presses said swing arm in such a manner that said tool magazine is coupled with said swing arm, said roller wheel is pivotally connected to said roller wheel adjusting base, and said tool tray coupled with said tool magazine casing body do not shake when said roller wheel slides between said flat portion and said concave portion on said linkage panel.

6. The fast tool changing system, as recited in claim 1, wherein said height difference between said flat portion and said concave portion of said linkage panel results in a height drop when said roller wheel slides on said linkage panel, wherein said enhanced pre-pressed torsional spring rotates to press against said swing arm, so that action of fast tool changing by means of synchronizing displacement of said tool magazine is achieved.
